(19) United States
(12) Patent Application Publication
(10) Pub. No.: US 2013/0340580 A1
(43) Pub. Date: Dec. 26, 2013

(54) TWO-AXIS DICING OF A WORK PRODUCT WITH A FLUID JET PORTIONER

(71) Applicant: John Bean Technologies Corporation, Chicago, IL (US)

(72) Inventors: John R. Strong, Redmond, WA (US); Jon A. Hocker, Bothell, WA (US); Arthur W. Vogeley, JR., Seattle, WA (US)

(21) Appl. No.: 13/843,260

(22) Filed: Mar. 15, 2013

Related U.S. Application Data
(60) Provisional application No. 61/660,621, filed on Jun. 15, 2012.

(51) Int. Cl. B26D 5/00; B26D 3/18; B26D 5/06

(52) U.S. Cl. CPC B26D 5/007; B26D 5/06; B26D 3/185
USPC 83/13; 83/155

(57) ABSTRACT

A portioning system (10) for cutting a work product (13) into a diced pattern as the work product is being carried by a conveyor (12). A cutter actuator (17) moves at least one cutter (18) parallel and transverse to the conveyor (12) either singularly or simultaneously at a speed significantly faster than the travel speed of the conveyor. A control system (220) is capable of controlling the direction and speed of movement of the cutter (18) and the conveyor (12) according to one or more directly controlled parameters including cutter pattern width, belt speed, cutter movement speed, cutter direction of movement, shape of desired end product(s), weight of desired end product(s), size of desired end product(s).

### CROSS-REFERENCE TO RELATED APPLICATION

This application claims the benefit of U.S. Provisional Application No. 61/660,621, filed Jun. 15, 2012, the disclosure of which is hereby incorporated by reference herein.

### BACKGROUND

Work products (for example, food products), in the form of continuous lengths or sheets or streams of meat, are typically laid out on a conveyor belt along the length of the belt and typically across the entire, or at least a significant portion of the, width of the belt. High speed fluid jet cutters are controlled to make a pattern of cuts in the meat, such as in the shape of squares, rhombuses, rectangles or parallelograms. The cutting action occurs in the work product sheet, length, or stream down the length of the belt. In many cases, the resulting diced meat pieces have the shape of the selected cutting pattern (squares, rhombuses, etc.), but where the cut pattern is crossing the edges of the incoming meat pieces, the resulting diced pieces will have at least some natural edge and their shape will not fully match the cutting pattern. Dicing cutters typically have sorting systems following them to separate the diced pieces that are within weight or dimensional specifications from out of specification pieces. Nevertheless, it is desired to produce the maximum percentage of “in specification” pieces.

The sheet of meat may be of varying heights at different locations about the sheet. Since the goal often is to try to target a specific weight (or weight range) for the resulting diced pieces, and the cutting pattern is fixed, height variations can result in undesirable weight variations among the diced pieces. A common solution is to have a pre-slicing operation that removes at least some of the highest areas of meat so that the weight variation of resulting diced pieces is reduced. Many pre-slicing machines are difficult to accurately adjust to the ideal height to achieve the desired weight of resulting diced pieces. Also, height adjustment may change over time due to changes in the incoming meat, build-up of meat within the slicing device, etc. Flattening machines are sometimes used instead of pre-slicers, or in conjunction with pre-slicers, to flatten the meat work products to a more uniform thickness.

A common type of dicing machine uses high pressure fluid (usually a liquid such as water) jets moving back and forth across the width of the belt at a uniform speed. If the velocity of the cutters going across the belt width equals the velocity of the belt, the result will be a pattern of square cuts. (See U.S. Pat. No. 5,243,886 for a detailed description of such a machine, which is incorporated by reference herein.) This type of machine will be referred to as a single axis dicer because the cutters only move in one direction, e.g. back and forth across the belt.

Another type of dicing machine moves the cutters in a “bow tie” pattern which means that the cutters travel diagonally across the belt in the downstream direction of the belt such that the actual cuts across the work product are in a straight line across the belt. A manifold of fixed cutters across the belt width make the down belt cuts to complete the squares or rectangles. (See U.S. Pat. No. 5,746,566 for a detailed description of such a machine, which is incorporated by reference herein.) Such cutters can perform other movements as well, rather than in straight lines across the belt. The means of creating this “bow tie” motion can be with servo-motors controlled by computers or by mechanical linkages. To some extent, this is a two-axis cutting machine, but of a very specific and limited type.

### The Limitations of Single Axis Dicing

Single axis dicing requires cross belt cutting speed (the speed of the cutters moving across the belt) to be the same as the belt speed in order to achieve the 45 degree cut path which results in a square diced pattern. Since humans have difficulty loading a conveyor belt moving at more than about 80 feet per minute, whereas waterjet cutting works quite well up to about 200 feet per minute cutting speed, there is an obvious mismatch of capability. At 80 feet per minute belt speed, the cutter speed relative to the work product would be 80*√2=113 feet per minute. Thus, the cutting capability is underutilized.

Single axis cutting also requires that the width of the cut pattern equals a distance determined by the number of cutting orifices×(orifice spacing/2). Thus, for a 12 orifice system cutting 1 inch square diced pieces (1.414 inch orifice spacing), the cut pattern width is only 12×1.414/2=8.5 inches. Work products in the form of individual pieces of meat that are to fill this cutting strip are typically on the order of 4 to 8 inches in length or width. Thus, the ability to effectively fill this cutting width with meat without leaving large empty gaps is quite limited. It would be better if the cutting pattern could be wider without adding more orifices.

### The Limitations of a “Bow Tie” Dicing Machine

The “bow tie” dicing approach, while conceptually acceptable in that the approach makes a desirable pattern of squares aligned with the product loading and belt movement, is inefficient because it requires so many orifices. First, it requires moving cutters to make the cuts across the product strip. Second, it requires more orifices cutting down the length of the product strip. Since added cutters represent higher capital cost for pumps and higher power consumption to power the pumps, this is not a good solution.

A second limitation, if an existing two-axis portioner is used, is that the width of the product strip is limited to the down belt travel capability or range of the fluid jet cutters. Since common cutters have a down belt travel limitation of somewhere around 8 inches, this solution gives the same narrow cut pattern width problem or limitation as a single axis dicing machine, as discussed above.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

A portioning system for cutting a continuous work product, perhaps in a sheet, into a diced pattern as the work product is being carried by a conveyor includes a plurality of cutters, each presenting a cutting line in a direction transverse to the plane of the conveyor. A cutter actuator moves the plurality of cutters parallel and transverse to the conveyor, either in one direction at a time, or simultaneously, and at a speed significantly faster than the travel speed of the conveyor. A control system controls the movement of the plurality of cutters and the conveyor according to one or more directly controlled parameters selected from the group consisting of cutter pattern width, belt speed, cutter travel speed, cutter direction of movement, shape of desired end product, weight of desired end product, and size of desired end product.

In a further aspect of the present disclosure, directly controlled parameters include cutting pattern width, cutter travel speed, and the shape of the end product. Based on the values selected for these directly controlled parameters, the portioning system determines the applicable belt speed.

In accordance with a further aspect of the present disclosure, the directly controlled parameters may include belt speed, cutter travel speed and end product shape. Based on the values of the directly controlled parameters selected, the portioning system determines the width of the cutting pattern.

In accordance with a further aspect of the present disclosure, the portioning system permits adjustment to the area or weight of the diced end product, and the portioning system determines and sets the shape of the end product to achieve the selected area or weight of the end product.

In a further aspect of the present disclosure, a scanner is used for scanning the work product prior to cutting. A control system of the present disclosure can recommend or automatically adjust the cutting pattern width based on the data from the scanner. Further, in accordance with the present disclosure, the control system can recommend or automatically adjust the shape of the diced end product based on the desired weight of the end product and the information from the scanner.

In accordance with a further aspect of the present disclosure, a slicer may be utilized before or after the cutter. The control system controls the slicer to slice the work product to a desired thickness.

A method for cutting a sheet of food into a repeating diced pattern as the food products are being carried by a moving support surface, comprising providing a cutter set comprising a plurality of cutters presenting cutting lines extending in a direction transverse to the moving support surface; scanning the sheet of food being carried by the moving support surface; and moving the cutter set along and/or across the moving support surface at a speed significantly faster than the travel speed of the moving support surface in a repeating dicing pattern, with the shape of the diced cut food products based on the desired physical parameters of the diced food products and the data from the scanner.

In accordance with a further aspect of the present disclosure, the diced food products include parameters selected from the group consisting of a shape of the diced food product, the weight of the diced food products, the thickness of the diced food products, and the size of the diced food products.

In accordance with another aspect of the present method, the movement of the cutter set relative to the moving support surface is in accordance with one or more control parameters selected from the group consisting of cutter pattern width, support surface movement speed, cutter set movement speed, and cutter set movement direction.

In a further aspect of the present disclosure, the sheet of food products is sliced either before or after dicing the sheet of food products to achieve a desired thickness, weight, or shape of the diced food products.

### BRIEF DESCRIPTION OF THE DRAWINGS

The foregoing aspects and many of the attendant advantages of the present invention will become more readily appreciated as the same become better understood by reference to the following detailed description, when taken in conjunction with the accompanying drawings, wherein:

FIG. 1 is a schematic view of a cutting (dicing) system in accordance with the present disclosure.

FIG. 2A provides a pictorial view of a cutter actuator of the present disclosure;

FIG. 2B is an enlarged pictorial view of a portion of FIG. 2A;

FIG. 2C is a view similar to FIG. 2B, showing an alternative embodiment of the present disclosure.

FIG. 3 is an enlarged pictorial view of a portion of FIG. 2A, with certain parts removed to enhance clarity;

FIG. 4 is a pictorial view similar to FIG. 3, but taken from the back side of the transverse carriage shown therein;

FIG. 5 is a cross-sectional view of a portion of FIG. 2A taken substantially along lines 5-5 thereof;

FIG. 6 is a cross-sectional view of FIG. 2 taken along lines 6-6 thereof.

FIGS. 7A, 7B, 7C and 7D are schematic cutting (dicing) patterns using the system and methods for the present disclosure to dice work products;

FIG. 8 is a schematic view of various rhombus shapes into which work products may be cut or diced; and

FIG. 9 is a graph showing the relationship between conveyor belt speed, cutting pattern width, down-belt travel distance of the cutter, and rhombus angle of the cut/diced end pieces.

### DETAILED DESCRIPTION

### Overall System

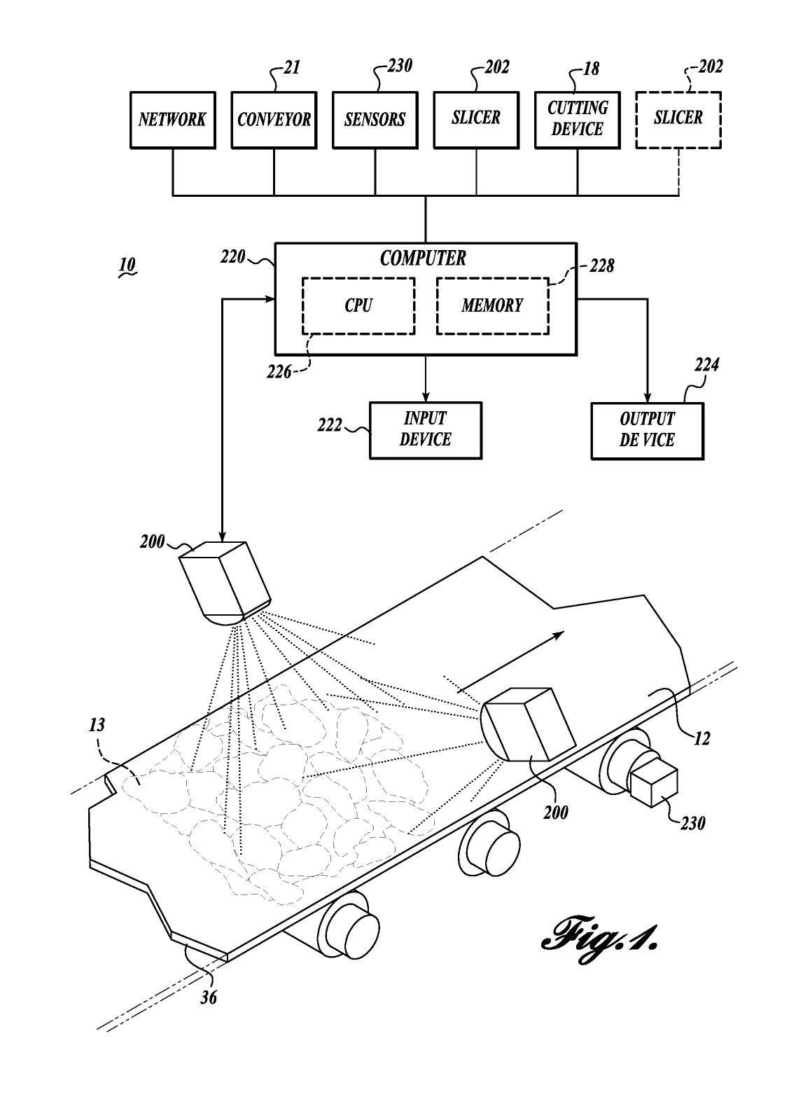

FIG. 1 schematically illustrates a system 10 suitable for implementing an embodiment of the present disclosure. The system 10 includes a moving support surface in the form of a conveyor 12 for carrying a work product 13 generally in the form of a sheet extending along the conveyor, to be portioned. The work product may be a food product such as meat, poultry, fish that are arranged as a sheet or stream extending along the conveyor. The sheet/stream may not always be uniformly continuous, but it is contemplated that the work product will extend generally continuously along the conveyor. Other types of work product may include, for example, sheets or lengths of rubber or cardboard, or a section of plastic or wood material extending along the conveyor. In a scanning aspect, the system 10 includes a scanner 200 for scanning the work product 13. In a cutting or dicing aspect, system 10 may include a cutter 18 (or an array or series of cutters similar to or the same as cutter 18) for dicing the work product into end pieces of desired sizes or other physical parameters. The portioning aspect of system 10 may also include a slicer 202 which is schematically illustrated as interposed between the scanner and the cutter. FIG. 1 also illustrates that the slicer 202, shown in broken line, may instead be located downstream from the cutter 18. The conveyor 12 and the scanner 200 are coupled to, and controlled by, processor or computer 220. The cutter 18 and slicer 202 are shown as coupled to the same computer 220, but may be instead coupled to a different computer (not shown). As illustrated, the processor/computer includes an input device 222 (keyboard, mouse, etc.) and an output device 224 (monitor, printer, etc.). The computer 220 also includes CPU 226 and a memory 228.

Generally, the scanner 16 scans the work product 13 to produce scanning information representative of the work product, and forwards the scanning information to the processor/computer 220. The processor/computer, using a scanning program, analyzes the scanning data to develop a thickness profile of the scanned work product. The processor/computer also develops a width, area and/or volume distribution of the scanned work product. The processor/computer 220 then can model the work product to determine how the work product might be divided and diced into end products composed of specific physical criteria, including, for example, shape, weight and/or thickness. In this regard, the processor/computer takes into consideration that the thickness of the work product may be altered either before or after the work product is diced by the cutter 18. The processor/computer, using the scanning program or the portioning program, determines how the work product may be diced into one or more end product sets. The processor 220, using the portioning software, then functions as a controller to control the cutter 18 as well as the slicer 202, to dice the work product according to the selected end products.

Describing the foregoing systems method in more detail, the conveyor 12 carries the continuous work product 13 beneath the scanning system 200. The scanning system may be of a variety of different types, including a video camera (not shown) to view a work product 13 illuminated by one or more light sources. Light from the light source is extended across the moving conveyor belt 36 to define a sharp shadow or light stripe line, with the area forwardly of the transverse beam being dark. When no work product 13 is being carried by the infeed conveyor 12, the shadow line/light stripe forms a straight line across the conveyor belt. However, when the work product sheet 13 passes across the shadow line/light stripe, the upper, irregular surface of the work product produces an irregular shadow line/light stripe as viewed by a video camera angled downwardly on the work product and the shadow line/light stripe. The video camera detects the displacement of the shadow line/light stripe from the position it would occupy if no work product were present on the conveyor belt. This displacement represents the thickness of the work product along the shadow line/light stripe. The length of the work product is determined by the distance of the belt travel that shadow line/light stripes are created by the work product. In this regard, an encoder 230 is integrated into the infeed conveyor 12, with the encoder generating pulses at fixed distance intervals corresponding to the forward movement of the conveyor.

In lieu of a video camera, the scanning station may instead utilize an x-ray apparatus (not shown) for determining the physical characteristics of the work product, including its shape, mass, and weight. X-rays may be passed through the object in the direction of an x-ray detector (not shown). Such x-rays are attenuated by the work product in proportion to the mass thereof. The x-ray detector is capable of measuring the intensity of the x-rays received thereby, after passing through the work product. This information is utilized to determine the overall shape and size of the work product 13, as well as the mass thereof. An example of such an x-ray scanning device is disclosed in U.S. Pat. No. 5,585,603, incorporated by reference herein. The foregoing scanning systems are known in the art and, thus, are not novel per se. However, the use of these scanning systems in conjunction with the other aspects of the described embodiments are believed to be new.

The data and information measured/gathered by the scanning device(s) are transmitted to the processor/computer 220, which records the location of the work product 13 on the conveyor 12, as well as the length, width and thickness of the work product about the entire work product. With this information, the processor, operating under the scanning system software, can develop an area profile as well as a volume profile of the work product. Knowing the density of the work product, the processor can also determine the weight of the work product or segments or sections.

Although the foregoing description discusses scanning by use of a video camera and light source, as well as by use of x-rays, other three-dimensional scanning techniques may be utilized. For example, such additional techniques may be by ultrasound or moiré fringe methods. In addition, electromagnetic imaging techniques may be employed. Thus, the present invention is not limited to use of video or x-ray methods, but encompasses other three-dimensional scanning technologies.

Various types of cutting devices 18 may be utilized to cut the work product 13 into smaller end portions. Examples of cutting devices include high speed waterjets, or lasers. Examples of a high speed waterjet cutting system are disclosed by Rudy, U.S. Pat. No. 5,365,816 and Pfarr et al., U.S. Pat. No. 5,868,056, incorporated by reference herein. The processor 220, operating under the portioning software, can control the cutting path of the cutting devices 18 to automatically dice the work product into a set of smaller end product portions. In this regard, the cutting device 18 presents a cutting line that may be vertical or otherwise transverse to the support surface of the conveyor. Of course, the cutting line can also be tilted or canted to present a cutting line that is other than vertical or transverse to the support surface of the conveyor.

As shown in FIG. 1 and as noted above, slicer 20 may be located either upstream or downstream from the cutter 18. Various types of slicers may be utilized to slice the work product into one or more desired thicknesses. For example, the slicer may be in the form of a high speed waterjet, a laser, a rotary saw, a hacksaw, or band saw. Also, the slicer may be adjustable so that a desired thickness of the work product is obtained. Such adjustment may be under the control of the processor 220 operating portioning software.

### Cutter

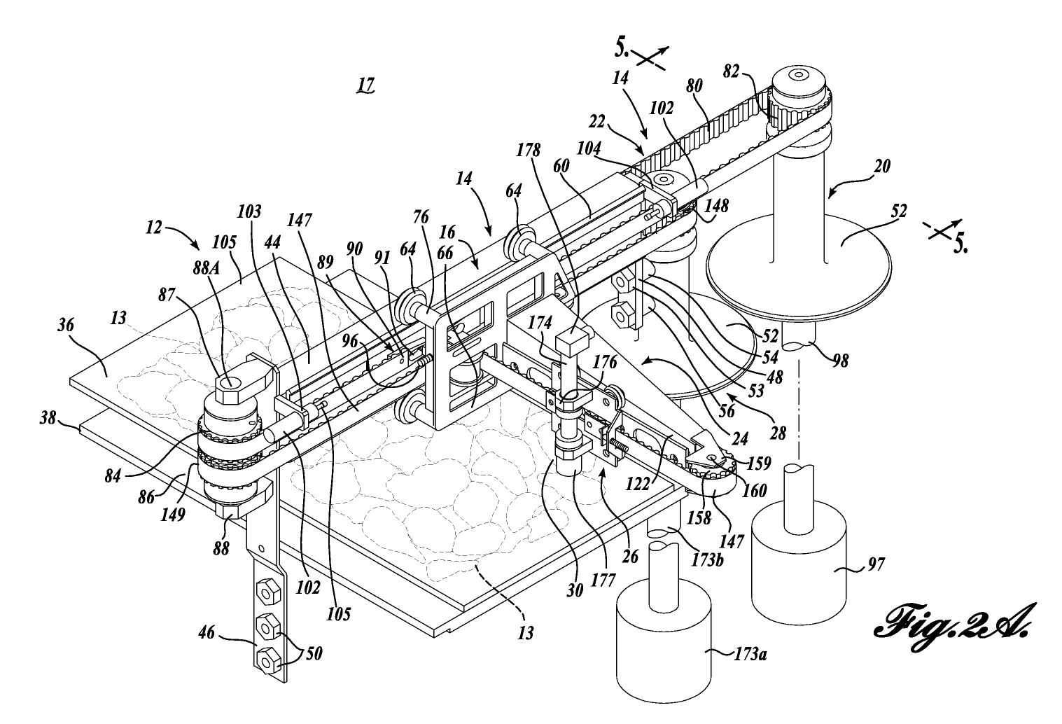

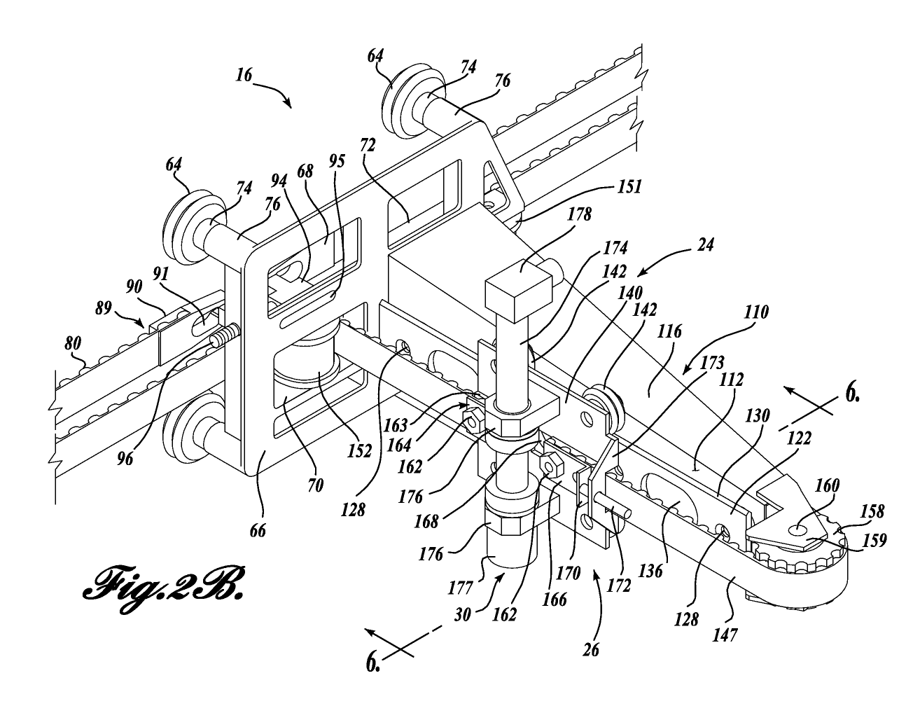

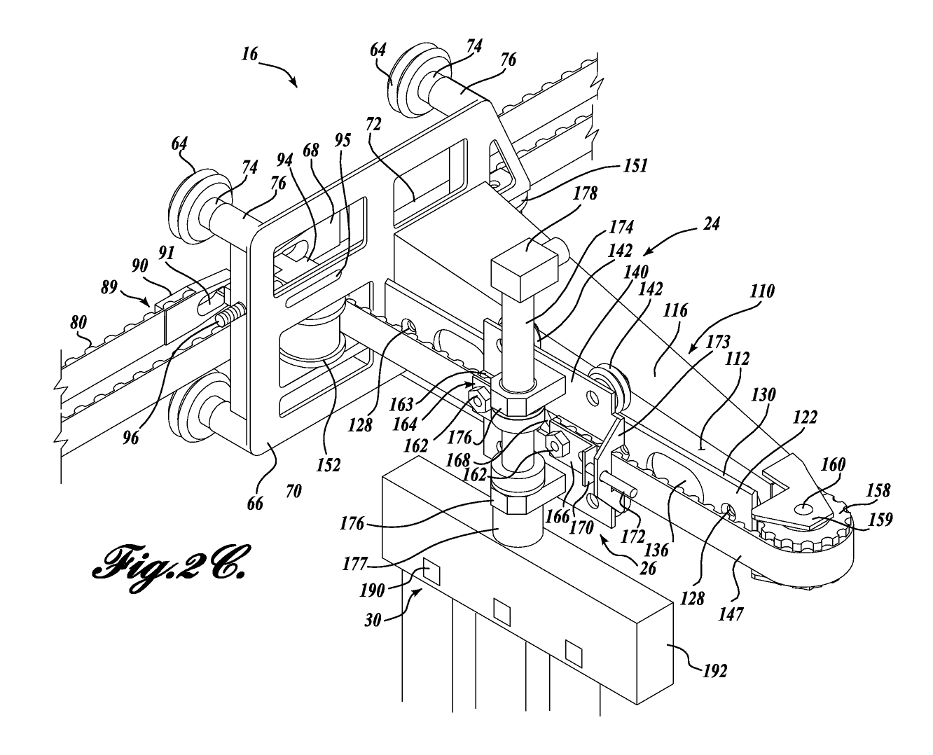

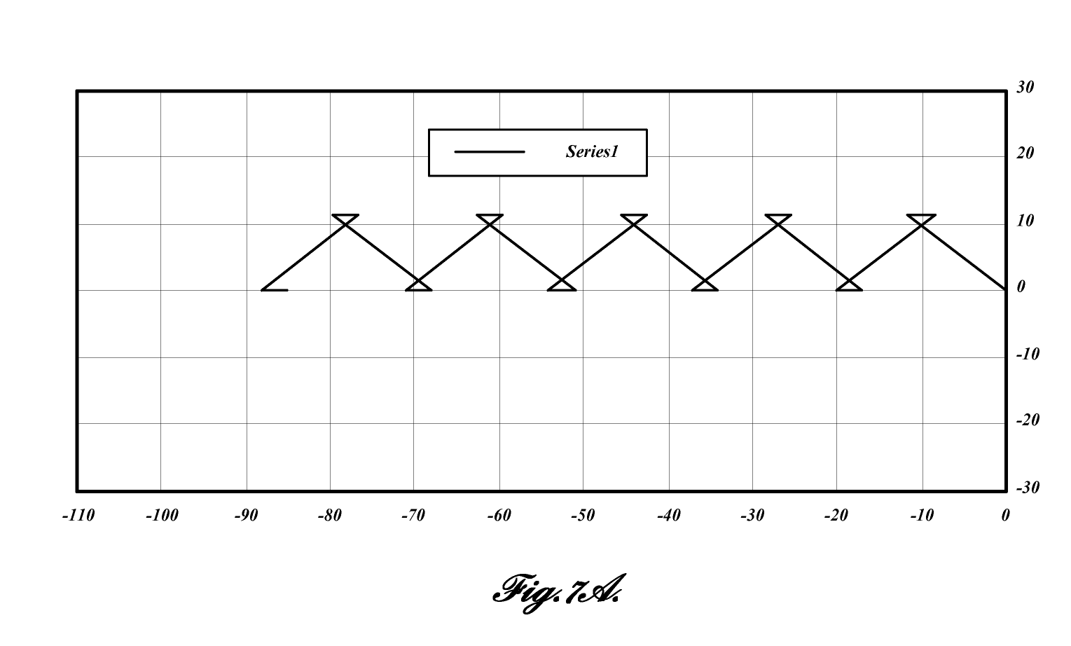

A cutter apparatus 17 is illustrated as mounted to a conveyor 12 (moving support surface) for supporting and moving work products 13. FIGS. 2A, 2B and 3-6 correspond to U.S. Pat. No. 5,868,056. The cutter apparatus 18 in basic form includes a support structure 14 extending across the conveyor for supporting and guiding a carriage 16 for movement transversely to the direction of movement of the conveyor. The carriage 16 is powered by a drive system 19 including in part a motive system 20 and a drive train 22. A second, longitudinal support structure 24 is cantilevered outwardly from carriage 16 in a direction generally aligned with the direction of movement of conveyor 12. A second longitudinal carriage 26 is adapted to move along longitudinal support structure 24 by the drive system 19. In this regard, a second motive system 28 powers the longitudinal carriage 26 through the drive train 22. A work tool 30 is mounted on the longitudinal carriage 26 to move therewith as the work tool operates on the underlying work product being carried by the conveyor 12.

As will be appreciated in the following more detailed description, the apparatus 17 of the present disclosure is designed with a minimum of moving mass so that the work tool 30 can be moved as quickly as possible relative to the work products, enabling the work tool to carry out precise operations on the work products at high speed. This is achieved at least in part by locating the motive systems 20 and 28 at stationary locations remote from the carriages 16 and 26. Also, a lightweight but highly durable drive system 19 is utilized to interconnect the carriages 16 and 26 to the motive systems 20 and 28.

Referring specifically to FIG. 2A, the conveyor 12 includes a moving belt 36 that slides over a support bed 38. The bed 38 is supported by underlying rollers carried by a frame structure (not shown) in a standard manner. The conveyor belt 36 is driven at a selected speed by a drive motor (not shown) in a standard manner. The drive motor can be composed of a variable speed motor to thus adjust the speed of the belt 36. The work products 13 are carried on the conveyor belt 36 to be operated on by the work tool 30.

Next referring specifically to FIGS. 2A and 2B, the transverse support structure 14 includes a beam structure 44 that spans transversely across the conveyor 12 at an elevation spaced above belt 36. Ideally the beam 44 is of hollow, rectangular construction, but may be formed in other manners and shapes without departing from the spirit or scope of the present invention. The ends of beam 44 are supported by upright brackets 46 and 48. As shown in FIG. 2A, bracket 46 is fixed to the adjacent end of the beam 44 to extend downwardly for mounting to conveyor 12. A plurality of hardware members 50 extend through clearance holes (not shown) formed in the lower, offset portion of bracket 46 to attach the bracket to the conveyor. Bracket 48 extends downwardly from the opposite end of beam 44 for attachment to the outer housing portion 52 of motive system 28. In this regard, hardware members 53 extend through clearance holes provided in the lower end of bracket 48 to engage with bosses 54 and 56 extending transversely from housing 52. In this manner, the beam 44 is mounted securely stationary on the conveyor.

Support structure 14 also includes a track for guiding carriage 16 along beam 44, composed of an upper rail 60 and the lower rail 62 attached to the face of beam 44 facing the carriage. As illustrated in FIG. 2B, the upper rail 60 extends along the upper corner of beam 44 whereas the lower rail 62 extends along the lower corner of the beam. As also illustrated, the upper surface of the upper track 60 and the lower surface of the lower track 62 are crowned to engage with the concave outer perimeters of the rollers 64 of carriage 16. As such, the carriage 16 is held captive on the track while traveling back and forth along beam 44.

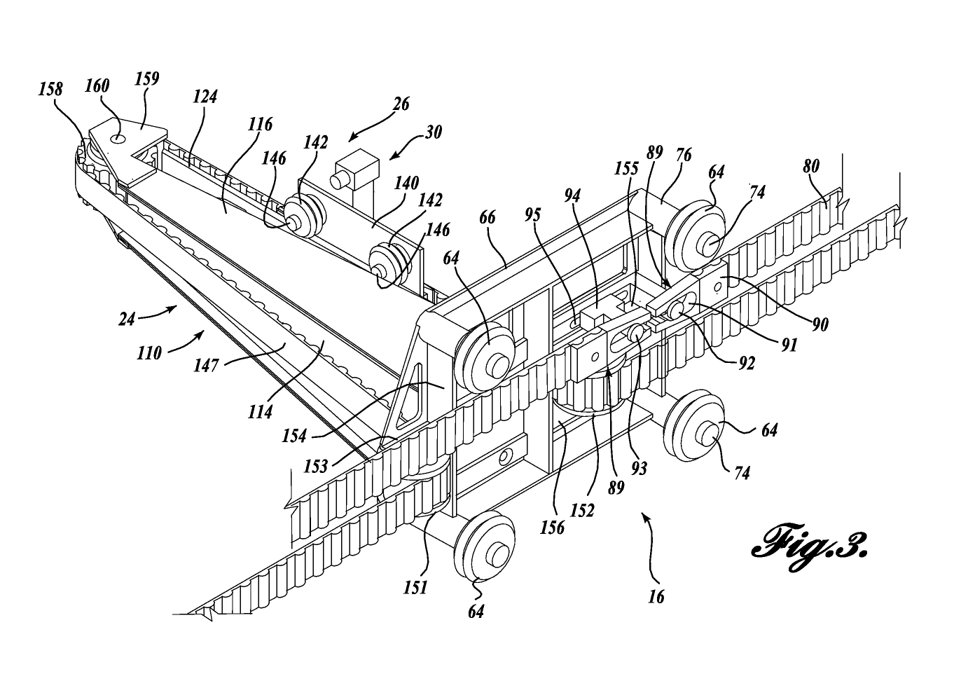

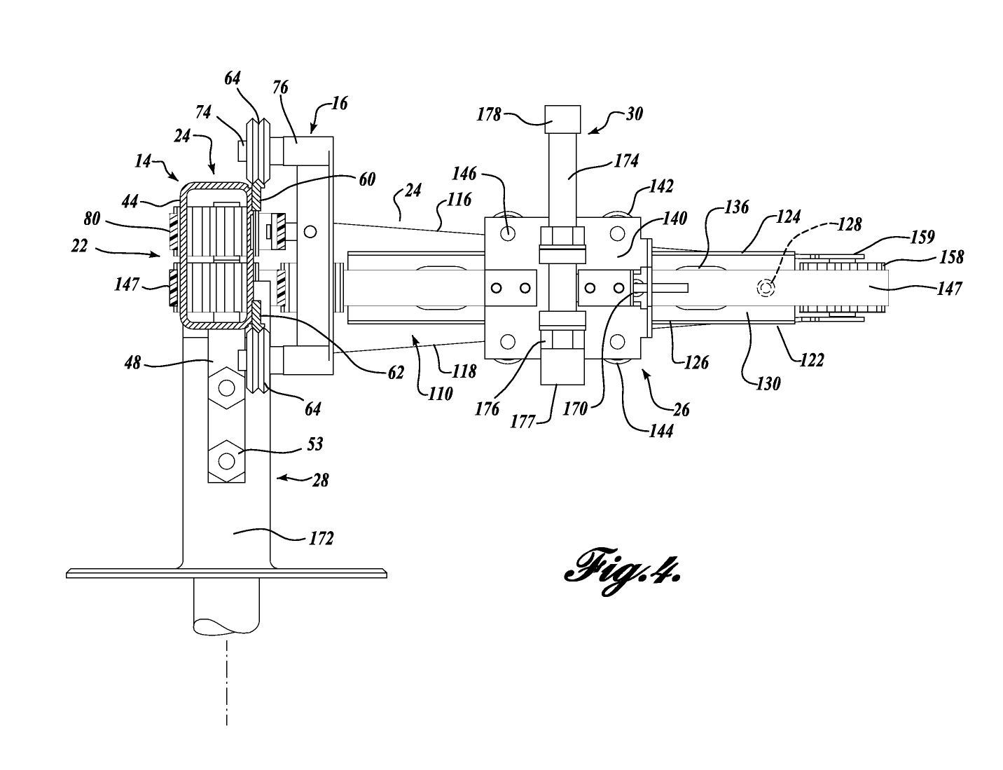

As most clearly illustrated in FIGS. 3 and 4, carriage 16 includes a substantially planar, generally rectangularly shaped bed portion 66 having the reinforced outer perimeter for enhanced structure integrity. Openings 68, 70 and 72 are formed in bed 66 to reduce its weight while retaining the structural integrity of the bed. The carriage rollers 64 are attached to the corners of the bed 66 by stub axles 74 which engage within through-bores formed in bosses 76 which extend transversely from each of the four corners of the carriage bed 66. Antifriction bearings (not shown) are utilized between the roller 64 and the stub axles 74 to enhance the free rolling of the carriage 16 along beam 44.

Carriage 16 is powered to move and back forth along beam 44 by drive system 19. In this regard, a timing belt 80 extends around a drive pulley 82 located at the upper end of motive system 20 and also around an idler pulley 84 of an idler assembly 86 mounted on the upper end of bracket 46 by upper and lower bracket ears 87 and 88. As such, the belt 80 makes a loop around the beam 44, extending closely along the sidewalls of the beam. The idler pulley 84 is adapted to rotate freely about central shaft 88A of the idler assembly 86 through the use of an antifriction bearing (not shown) with the upper and lower ends of the shaft being retained by bracket ears 87 and 88.

The ends of belt 80 are connected to the backside of carriage bed 66. As most clearly shown in FIGS. 2A, 3 and 4, clips 89 are clamped to the ends of belt 80 for use in attaching the ends of the belt to the carriage 16 in a quick release manner. Each of the clips 89 includes a clamping face 90 for attachment to an end of the belt 80. The clips 89 also include an elongated slot portion 91 for engagement over pin 92 anchored to carriage 16 and anchor pin 93 extending transversely from a slide block 94 keyed within a longitudinal, horizontal slot 95 extending along a carriage bed 66. A threaded pin 96 extends outwardly of a slide block 94 in a direction substantially perpendicular to pin 93 to engage within a threaded hole formed in the perimeter of carriage bed 66 to extend outwardly of the carriage bed. The tension of belt 80 is adjusted by rotation of pin 96.

As shown in FIG. 4, the end of clip 89 is not closed, but rather the slot portion 91 is open, with the opening being of a width somewhat narrower than the diameter of anchor pin 92. It will be appreciated that if carriage 16 is ever in a “runaway” condition or if motive system 20 malfunctions tending to cause the carriage to overrun beam 44, the belt 80 can detach from the carriage 16 by separation of the end of clip 89 to cause the clip to longitudinally slide off of the anchor pin 92. As such, potential damage to apparatus 10 may be avoided or at least minimized.

Ideally, the motive system 20 includes a servo motor 97 programmable to control the movement of the carriage 16 back and forth along beam 44 as desired. The servo motor is located below housing 108 at a location substantially insulated from moisture or other contaminants that may be associated with the work being carried out on the work products. A drive shaft 98 extends up from the servo motor through housing 108 to power the drive pulley 82. The drive shaft is antifrictionally supported within housing 108 by a pair of bearings 99 and 100. The lower end of the drive shaft 98 is coupled to the output shaft of motor 97 by coupling collar 101. The drive pulley 82 is securely attached to the upper free end of drive shaft 98 by any convenient method, such as by use of a key and key way, splines, shear pin etc. It will be appreciated that by the foregoing construction, the servo motor is located remotely from the carriage 16, with the driving force applied to the carriage 16 by the lightweight timing belt 80.

Although ideally motive system 20 utilizes a servo motor, other types of electrical, hydraulic or air motors may be employed without departing from the spirit or scope of the present invention. Such motors are standard articles of commerce.

By the foregoing construction, motive system 20 is capable of quickly accelerating and decelerating carriage 16 for movement along beam 44. To assist in the deceleration of the carriage 16, shock absorbers 102 are mounted at each end of beam 44 by brackets 103 and 104 extending outwardly from the beam. Ideally, but not essentially, the brackets 103 and 104 may be integrally constructed with brackets 46 and 48, respectively. The shock absorbers 102 include a plunger 105 directed at the end edges of carriage bed 66. Although not shown, a piston is attached to the plunger 105 within the interior of the shock absorber cylinder which is filled with a fluid to resist the retraction of the plunger 105 in a manner similar to a “standard” hydraulic shock absorber. Also, the shock absorber 102 includes an interior compression spring (not shown) that nominally extends the plunger 105 longitudinally outwardly from the shock absorber cylinder. As such, if the carriage bed 66 strikes against one of the plungers 105, the plunger retracts somewhat when bringing the carriage 16 to a stop.

Next, referring specifically to FIGS. 2A, 2B, 3 and 4, the longitudinal support structure 24 cantilevers transversely from carriage 16 to be carried by the carriage. The support structure 24 includes a beam member 110 composed of a vertical sidewall 112 which is substantially perpendicular to the adjacent face of carriage bed 66. The opposite sidewall 114, rather than being substantially perpendicular to the carriage bed 66, tapers towards sidewall 112 in the direction away from the carriage bed. Likewise, the top and bottom walls 116 and 118 of beam 110 taper towards the free end of the beam 110, thereby to cooperatively form a generally peaked or pyramid shape. As will be appreciated, this enhances the structural integrity of the beam while reducing its weight relative to a parallel piped structure.

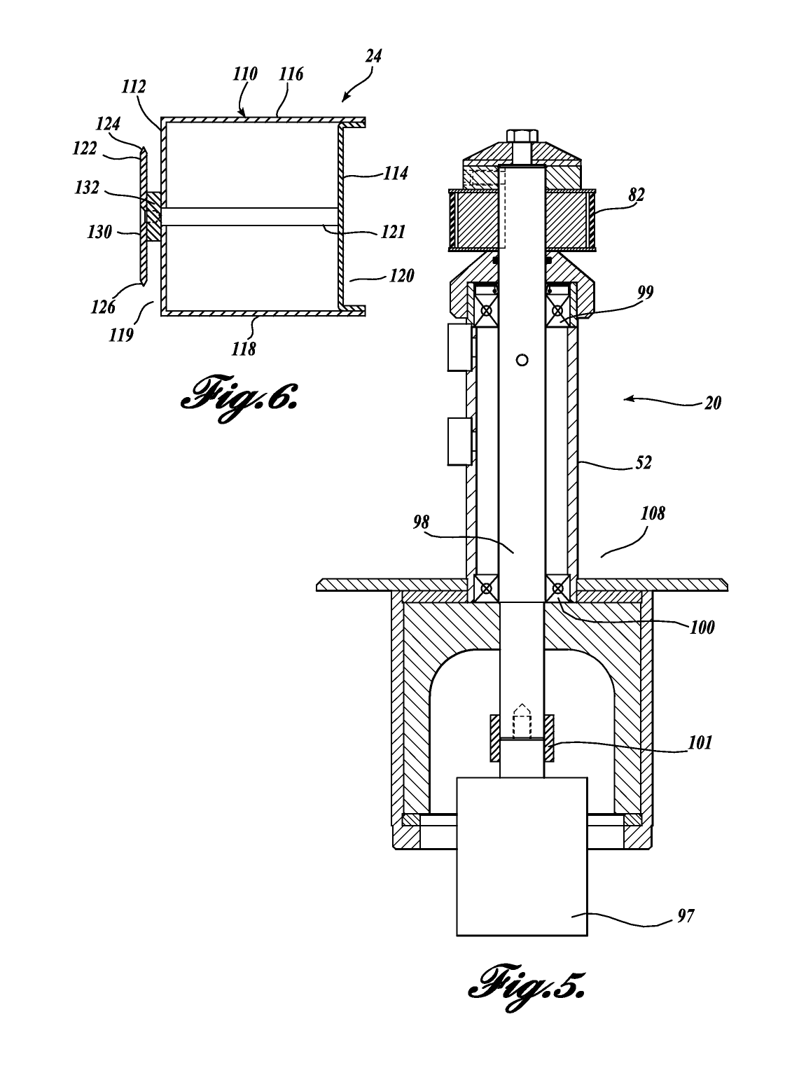

As illustrated in FIG. 5, ideally the beam 110 is of hollow construction, composed of two channel-shaped members 119 and 120. Channel member 120 nests within channel member 119 so that the flanges of channel member 120 overlap the free end edges of the flanges of channel 119, as shown in FIG. 5. A plurality of spacers 121 are disposed within the beam member 110 and located along its length to bear against the side walls 112 and 114 of the channel members 119 and 120. The flanges of the two channel members are attached together and the spacers 121 are attached to the channel members by any convenient means, including by weldments. It will be appreciated that by the foregoing construction, beam 110 is not only lightweight, but also of sufficient structural integrity to carry significant weight without deflection. Lastly, beam 110 may be secured to the carriage bed 66 by any appropriate technique, including by hardware fasteners, weldments, etc.

Support structure 24 includes an elongate track 122 extending longitudinally along and mounted on beam sidewall 112. Track 122 includes formed upper and lower edge portions 124 and 126 that are spaced away from sidewall 112 to define upper and lower rails for guiding the longitudinal carriage 26. As most clearly illustrated in FIGS. 2 and 3, the track 122 is attached to beam sidewall 112 by a plurality of hardware members 128 and extend through clearance holes formed in the track web portion 130 and through spacers 132 fixedly mounted to sidewall 112 at the back side of the track to engage the beam 110. Also to minimize the weight of track 122, cut-out openings 136 are formed in the track web portion.

The longitudinal carriage 26 is adapted to travel along track 122. In this regard, the carriage 26 includes a substantially planar, rectangularly shaped bed portion 140 and a pair of upper rollers 142 and a pair of lower rollers 144 having concave outer perimeter portions sized to closely engage with the correspondingly crowned track upper and lower rails 124 and 126. The rollers 142 and 144 are mounted on stub shafts extending transversely from the carriage bed 140. Ideally, but not shown, anti-friction bearings are utilized between the stub shafts 146 and the rollers 142 and 144 to enhance the free movement of the carriage 26 along track 122.

Carriage 26 is moved back and forth along track 122 by drive system 19. In this regard, the drive system includes the second motive system 28, constructed similarly to motive system 20, to power a timing belt 147. As perhaps most clearly shown in FIG. 1, the timing belt 147 is trained around a drive pulley 148 mounted on the upper end of motive system 28 and also trained around an idler pulley 149 located below idler pulley 84 on the idler assembly 86 which is secured to the end of beam 44 opposite the motive system 28. As such, the belt 147 also extends along the opposite sidewalls of beam 44, but at an elevation spaced below belt 80.

The belt 147 also trains around idler pulleys 151 and 152 mounted on transverse carriage 16. As illustrated in FIG. 4, the idler pulley 151 is mounted to an upper bracket plate 153 and a lower similar bracket plate (not shown), extending transversely outwardly from the end perimeter wall 154 of the carriage. A vertical shaft extends between these two bracket plates and through the longitudinal center of the roller pulley 151. Idler pulley 152 is mounted between a pair of parallel, spaced apart frame plates 155 and 156. As with idler pulley 151, idler pulley 152 rotates about a vertical shaft extending between the two frame plates. The idler pulleys 151 and 152 redirect the belt 147 to extend along the sides of transverse beam 110. Antifriction bearings (not shown) are employed to enable the idler pulleys 151 and 152 to freely rotate about their respective vertical shafts.

A further idler pulley 158 is mounted on the free end of beam 44 by a formed bracket 159 which is fixedly attached to the beam 110. An axle shaft 160 extends through the center of an antifriction bearing mounted within pulley 158, with the ends of the shaft retained by the upper and lower ears of bracket 159.

The ends of belt 147 are attached to the bed 140 of carriage 26. To this end, one end of belt 147 is clamped to the carriage bed by hardware members 162 that extend through close-fitting clearance holes formed in a clamping plate 163 to clamp the end of the pulley to an underlying clamping plate 164 mounted on the outer face of carriage bed 140. The opposite end of belt 147 is clamped to a slide bar 166 which is sized to slide within a horizontal slot 168 formed in the carriage bed 140. A tab 170 extends generally transversely from the end of slide bar 166, and a threaded lock pin 172 in turn extends transversely from the tab to engage within a threaded hole formed in a flange 173 extending transversely from the adjacent end of carriage bed 140. The tension of belt 147 is adjusted by rotation of lock pin 172.

Rotation of drive pulley 148 results in movement of the belt 147 which in turn causes the transverse carriage 26 to move along track 122. As with motive system 20, ideally motive system 28 includes a servo motor 173a which is drivingly connected with drive pulley 152 by a drive shaft 173b that extends upwardly through housing 52 of the motive system. However, as with motive system 20, other types of well known and commercially available rotational actuators may be utilized in placed of a servo motor. Also as with motive system 20, it will be appreciated that motive system 28 is located remotely from not only transverse carriage 16, but also longitudinal carriage 26. As a result, the mass of the motive system 20 is not carried by either of the two carriages, rather the motive system is positioned at a stationary location, with the drive force being transferred from motive system 28 to carriage 26 by a lightweight timing belt 147. As a consequence, the total mass of the moving portions of apparatus 10 (carriage 16, support structure 24 and carriage 26) is kept to a minimum. This allows extremely high speed movement of the two carriages, with accelerations exceeding eight gravities.

A work tool 30 in the form of high pressure liquid nozzle assembly is mounted on the longitudinal carriage 26 to move therewith. The nozzle assembly emits a very focused stream of high pressure water disposed in a vertical cutting line that is transverse to the plane of conveyor belt 36. The nozzle assembly includes a body portion 174 that is secured to the carriage bed 140 by a pair of vertically spaced apart brackets 176. The nozzle assembly 30 includes a lower outlet tip 177 directed downwardly toward conveyor belt 36. An entrance elbow 178 is attached to the upper end of nozzle body 174. High pressure liquid nozzles of the type of nozzle 30 are well known articles of commerce.

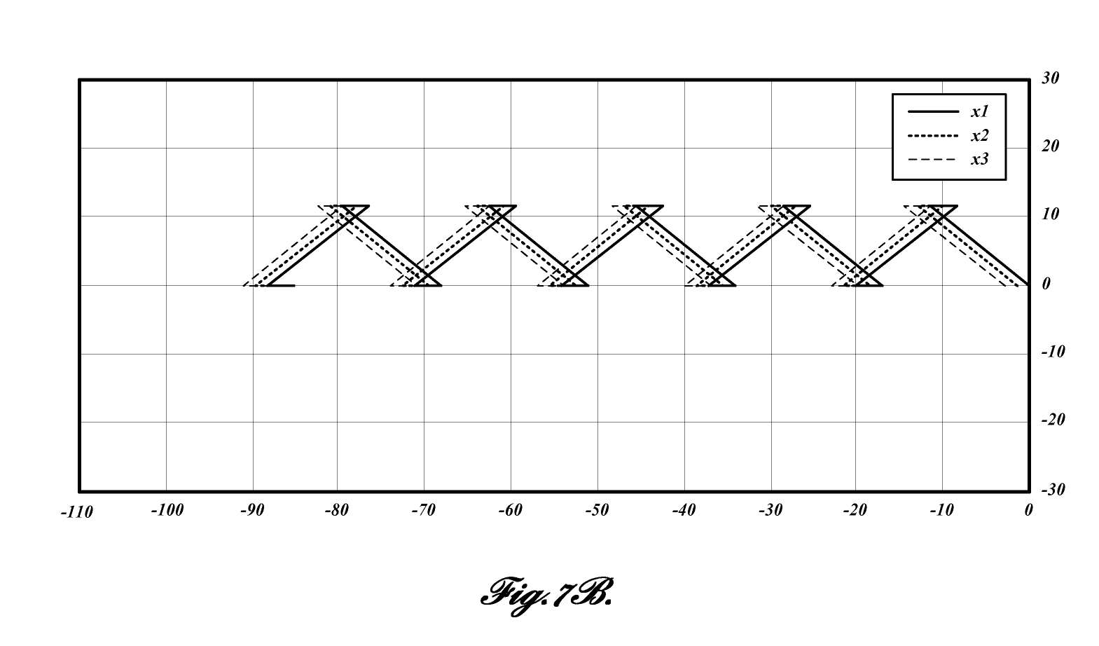

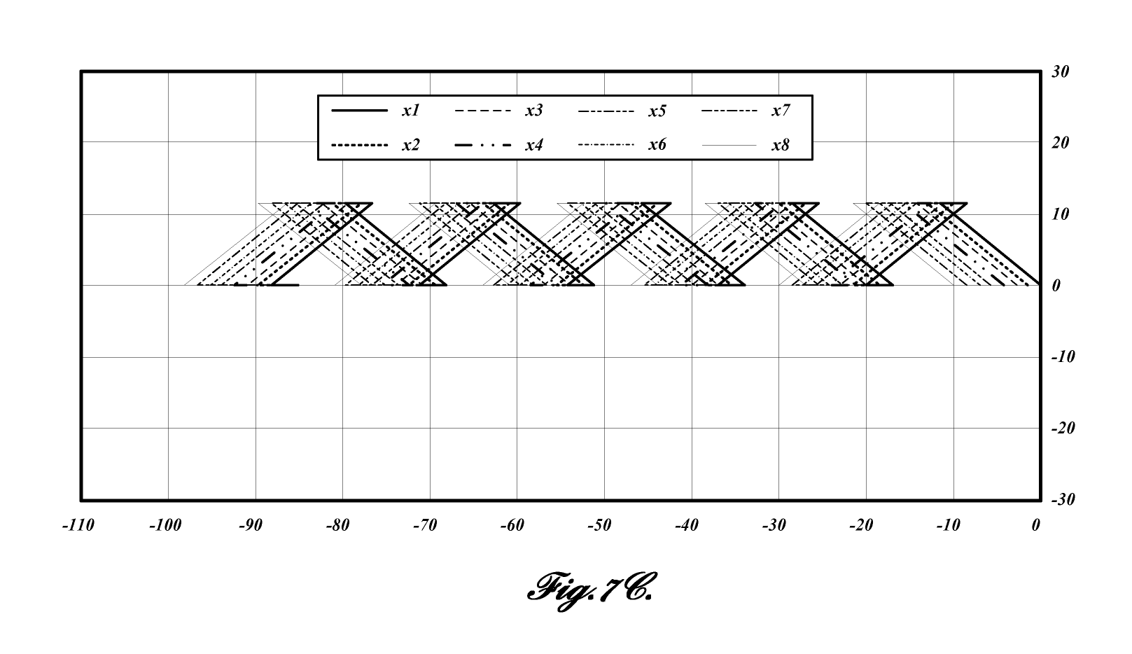

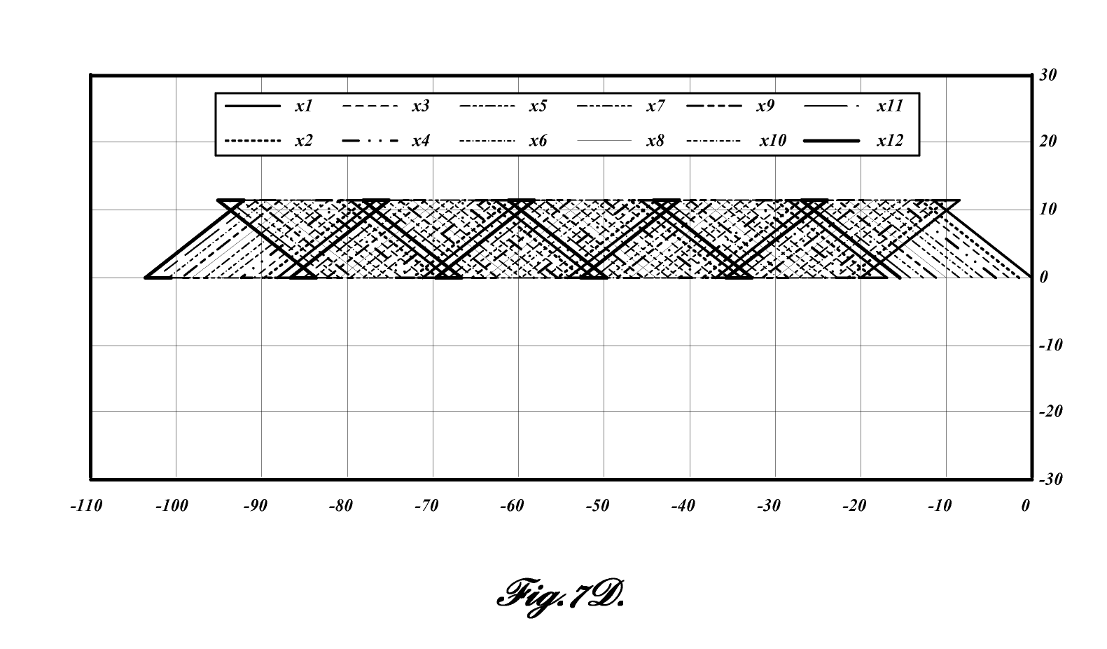

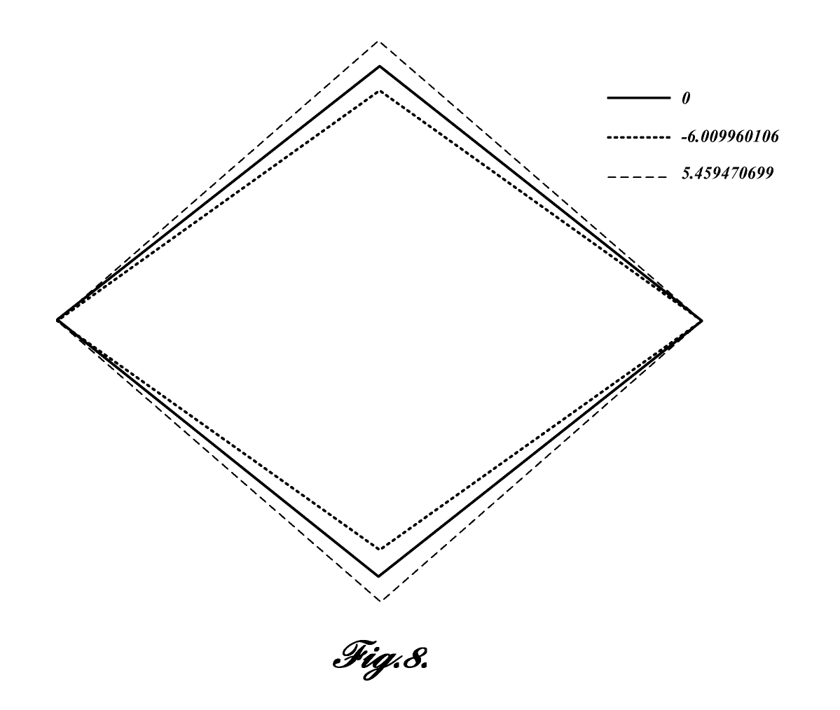

Rather than using a single work tool 30 in the form of a high pressure waterjet nozzle, which is illustrated in FIGS. 2A, 2B and 4, cutter 18 can be composed of a plurality of nozzles carried by longitudinal carriage 26. Such plurality of nozzles can be incorporated into a manifold such as those manifolds illustrated in U.S. Pat. No. 5,243,886. In this regard, see FIG. 2C, wherein a plurality of waterjet nozzle orifices 190 are incorporated into a manifold 192. The orifices are spaced apart from each other at a desired distance, and all of the orifices move in concert with each other. In one form of the present disclosure, a manifold can have three nozzles spaced approximately 1.4 inches apart, when used with a system 10 having four such manifold arrangements. This will enable the apparatus 17 to make the cutting pattern, shown in FIG. 7D.

Manifolds 192 can each be carried by a separate longitudinal carriage such as carriage 26, shown in FIG. 2C, which extends from a transverse moving carriage such as carriage 16. Alternatively, the carriages 26 carrying the manifolds 192 may each extend from a separate transverse carriage, similar to carriage 16. Other than the attachment of manifold 192 to a modified nozzle assembly 30, the apparatus shown in FIG. 2C is otherwise the same as, or substantially the same as, the apparatus shown in FIG. 2B.

### Two-Axis Dicing

An improved method for dicing using a two-axis portioning machine (see U.S. Pat. No. 5,868,056 for a detailed description of such a machine, which is incorporated herein by reference) and system is to utilize the cutter travel, that is upstream relative to belt travel direction, thereby moving “against” the belt travel direction, to make cutter travel or movement velocity independent of belt velocity. Software operated by computer 220 controls the trade-offs of belt velocity, cutting path width, rhombus angle and cutter travel speed to provide direct control over the factors that are of significance to food processors and others:
Control of cutting path width
Control of belt speed
Control of cutter travel or movement speed relative to the product Control of cutter travel direction
Control of diced piece weight via changes in rhombus angle

The methods and system of the present disclosure can be illustrated by initially limiting the method to making a square dice, where the cutters, such as nozzle assembly 30, trace 45-degree paths relative to the work product. In this example, the limitations previously mentioned are utilized of belt speed at 80 feet per minute and cutter travel/movement speed of 200 feet per minute, which equates to 16 inches per second for the belt speed and 40 inches per second for the cutting speed for more convenient units. For an assumed cut pattern width of 11.5 inches, it takes 0.41 seconds for the cutters to cross the belt 36, advancing 5 inches against the belt travel in the process ((11.5 inches×√2)÷40 inches/second=0.41 seconds). During the same 0.41 seconds, the belt advances 6.5 inches (0.41 seconds×16 inches/second=6.5 inches), resulting in the total down belt motion of the cutter relative to the product to 6.5+5=11.5 inches, which is the same as the belt width. As such, the cut path is at 45 degrees. The total travel distance between cutter and product on this 45 degree path is 11.5×√2=16.3 inches. In the 0.41 seconds, the cutter travels 16.3 inches/0.41 seconds=40 inches per second, which is the target cutting speed. Thus, this dicing method utilizes the fact that the cutter can be moved at a much faster speed than the speed of the moving conveyor. In the present situation, the cutters can be moved at a speed at least 1.7 times the speed of the conveyor belt.

Before the cutter can go back across the belt to make another (returning) 45 degree cut, the 5 inches of down belt travel of the cutter is recovered, which requires another 0.122 seconds to accelerate, travel at peak velocity, and decelerate. By the time the cutter has made two of these passes (across the belt and back), a time of 2×(0.41+0.122)=1.06 seconds has passed and the belt has traveled 1.06 seconds×16 inches per second=17 inches. With a total of 12 cutters (three orifices each on four cutter mechanisms) spaced 1.414 inches apart to cut a 1-inch square dice pattern, the down belt length taken up by these orifices is 12*1.414=17 inches. Thus, this describes a dicer for 1 inch product, an 11.5 inch cut pattern, and the desired belt and cutter travel speed. FIGS. 7A to 7D illustrate the cut pattern described above, shown with 1 cutter, 3 cutters, 8 cutters and the full 12 cutters for easier visualization rather than just looking at 12 cutters from the start. The belt can be imagined as the page the graph is on is slowly moving the right. The first cutter, initially at position 0,0, moves across the belt and to the left, then recovers the down belt travel, then moves back across the belt and to the left, then recovers down belt travel. Meanwhile, the belt steadily moves to the right, 17 inches in this example. The pattern repeats. Additional cutters are added to the left of the first cutter.

The example above is, of course, just one of many solutions that are possible by varying any and all of the noted variables. In this regard, providing a controlled down belt movement of the cutter enables the cut pattern width to increase to make belt utilization higher, allows the cutter travel speed to increase to the full capability of the cutter, and allows the belt speed to decrease to a reasonable speed for the people loading work products, such as foodstuffs, on the belt.

The maximum travel speed of the cutters relative to the work product to give a clean cut and full separation of the diced pieces depends upon the fluid (water) pressure, the work product (for example, meat) thickness, the orifice size, the work product toughness, work product density, presence of connective tissue (if the work product is meat), the orifice stream quality and, of course, the tolerance for a few diced pieces not achieving complete separation. For example, a user may start using a portioner in a dicing operation with one size of pump and may later decide to increase throughput by putting in a larger pump (more pressure or larger orifice size) which would permit a higher cutter travel speed. Another example would be a user dicing chicken breast meat in the morning and deboned chicken leg meat in the afternoon. Thus, it is useful for the user to have control of cutter travel speed, although the essential features of the present disclosure would still be present if the cutter speed was fixed.

### Dice Weight Adjustment by Allowing Off-Square Shape

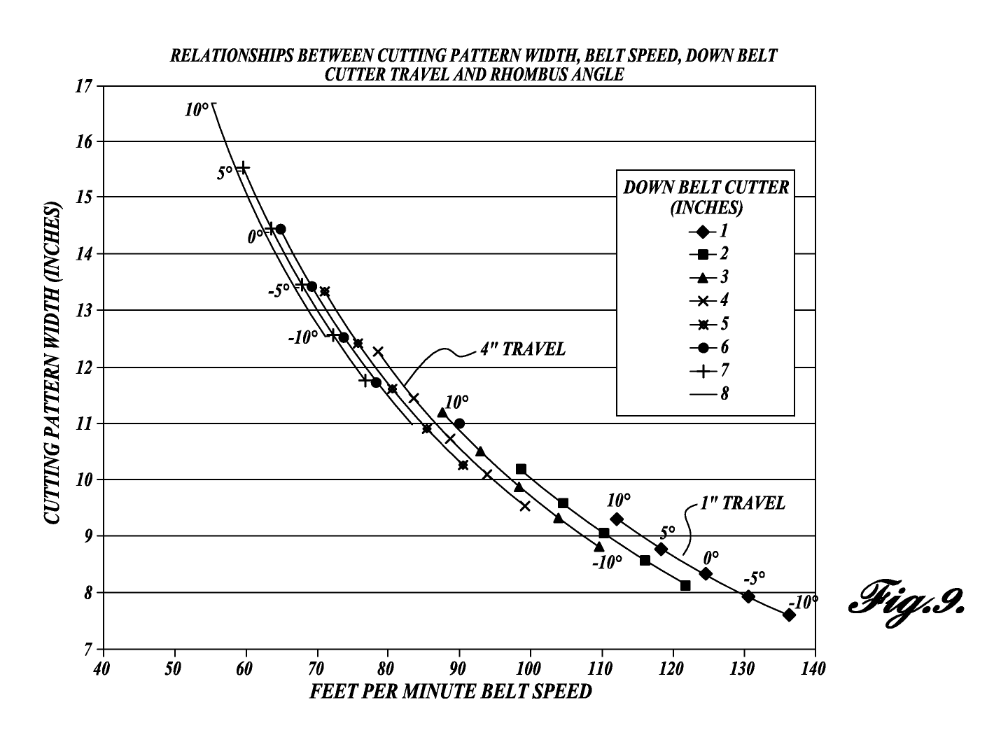

Most customers of diced product (for example, food product) typically are targeting a shape that is quite close to square. However, allowing the shape to be a few degrees off of square (e.g., a rhombus) can at times simplify or facilitate the dicing operation by enabling small weight adjustments without having to change the slice height or orifice spacing of the cutters. FIG. 8 illustrates three different dice (rhombus) shapes made from the same orifice spacing. The middle figure is square, the rhombus-shaped inner figure weighs approximately 10% less for the same thickness of the work product, and the rhombus-shaped outer figure weighs 10% more for the same thickness of the work product.

The same range of shapes can, of course, be produced with a single axis dicer by changing the cutting pattern width. The inner figure would require a narrow cutting pattern width and the outer figure would require a wider cutting pattern width. The problem is that when making small weight adjustments, it is not desirable to be required to be making changes to the loading pattern of the work product on the belt at the same time. With the added flexibility of two-axis dicing, the cutting pattern width can be kept constant during dice shape (weight) adjustments, compensating with belt speed and measurement of upstream cutter travel instead.

### Two-Axis Dicing Machine Control Description

The overall relationship between the cutting pattern width and belt speed for a typical situation of cutting a rhombus shaped dice with length of sides equal to 1 inch using 12 cutters, for rhombus angles from perpendicular from −10 degrees to +10 degrees, and upstream travel of the cutters (opposite the belt direction) of 1 to 8 inches is shown in FIG. 9. The following provides an example of the present method using the graph of FIG. 9 to better understand the control that can be realized with these relationships.

If it is desired to cut a square dice (0 degrees rhombus angle from perpendicular) with a 9-inch cutting pattern width, this can be done with 2 inches of down belt cutter travel and a belt speed of 111 feet per minute. If it is desired to change the weight of the diced pieces by changing the rhombus angle without changing the 9-inch cutting pattern width, then a rhombus angle of 7 degrees could be achieved with 1 inch of down belt cutter travel and a belt speed of 115 feet per minute, or a rhombus angle of −8 degrees could be achieved with an up stream cutter travel of 3 inches relative to the belt, and belt speed of 107 feet per minute.

The control system, including applicable software, of the present disclosure turns these relationships into useful functionality in the dicing machine. Some examples of useful functionality are noted in the paragraphs below:

### Functionality

1. Select as directly controlled parameters the cutting pattern width, cutter travel speed and rhombus angle (usually square dice). The present system and method determines the maximum belt speed and cutter travel distance in the belt travel direction;
2. Select belt speed, cutter travel speed and rhombus angle as directly controlled parameters. The present system and method will find and set cutting pattern width;
3. Select dice weight or area change from current setting based upon quality assurance test results as directly controlled parameters. The present system and method finds and sets rhombus angle and recommend belt speed, while holding cutting pattern width and cutter travel speed constant.
   Functionality with Use of Scanner Using the Present System and Method
1. The present system and method can determine product width automatically based upon scanner data for the product on the belt and then set or recommend the cutting pattern width;
2. Setting a dice weight specification and then using the scanner data to determine typical weight as diced, then the present system and method automatically determines the rhombus angle adjustments that should be made to meet the specification and set or recommend the rhombus angle;
3. Specify a dice weight specification and then using the scanner data to determine typical weight as diced, automatically determine the pre-slicer height adjustments that should be made to meet the specification and set or recommend the height adjustments;
4. Use the present system and method to determine the mass flow of product through the dicer.

### Some Unique Features of the Two-Axis Dicing Machine and Method of the Present Disclosure

1. Produces multiple cutter jet orifices per two-axis cutter;
2. De-couples cutter speed from belt speed;
3. Uses down belt cutter motion in a two-axis cutter to enable the cut across the conveyor belt to happen faster than the corresponding motion of the conveyor belt;
4. Uses vision (e.g., scanner) system to gather data in a pattern cutting situation and using such scanner data to make or recommend adjustments to the pattern being cut.

### Slicing

As a further aspect of the present disclosure, the work product, e.g., food product, may be sliced to desired thickness in conjunction with dicing to a particular size, shape, or weight. The slicing can be used in conjunction with the dicing to achieve desired sizes and weights for the end product. Using slicer 202, the food product 13 can be sliced prior to being diced by cutting device 18. Alternatively, especially if the food product 13 is diced into a large enough size, slicing can occur after dicing, which is also schematically shown in FIG. 1. In addition to achieving diced pieces of a desired weight, the slicing can remove “high points” or other features extending from the surface of the food product; for example, if it is desired to have the final food product of a uniform appearance or shape.

### SUMMARY OF SOME ASPECTS OF THE PRESENT DISCLOSURE

A two-axis portioner system and method of the present disclosure has at least one cutter and at least one orifice per cutter which uses varying amounts of cutter travel against the belt travel direction to achieve a dicing pattern on the belt, thereby providing flexibility with regard to cutting pattern width, belt speed, cutter travel speed and angle of the resulting rhombus cuts.

Wherein the system and method of the present disclosure also allows the user to select cutting pattern width, cutter travel speed and rhombus angle and the software determines and sets the belt speed.

Wherein the system and method of the present disclosure also allows the user to select the belt speed, cutter travel speed and rhombus angle and the software determines and sets the cutting pattern width.

Wherein the system and method of the present disclosure also allows the user to make adjustments to the diced piece area or weight and the software determines and sets a new rhombus angle to achieve the new weight.

Wherein the system and method of the present disclosure, in which the two-axis cutter has multiple orifices.

Wherein the system and method of the present disclosure, in which the cutter travel speed is decoupled from the belt speed.

The system and method of the present disclosure can include a two-axis portioner having a scanner, at least one cutter and at least one orifice per cutter which uses varying amounts of cutter travel against the belt travel direction to achieve a dicing pattern on the belt, thereby providing flexibility with regard to cutting pattern width, belt speed, cutter speed and angle of the resulting rhombus cuts.

A two-axis portioner further including software that recommends or automatically adjusts cut pattern width based upon scanned width data of the incoming work product.

A two-axis portioner that further includes software that recommends or automatically adjusts rhombus angle based upon the desired weight and the scanned height data.

A two-axis portioner that further includes software that monitors the volume/mass flow of work product being diced.

A two-axis portioner that further includes software that monitors the height of the pre-sliced work product and recommends or sends a signal to automatically adjust the slicer height to achieve the desired diced weight.

It will be appreciated that the present disclosure provides a dicing apparatus and system that differs significantly from the one-axis cutting approach noted above, wherein the number of nozzles and the distance between the nozzles set the cut width. In addition, in the one-axis approach, the belt speed and cutter travel speed must match in order to achieve continuous back-and-forth cutting. As a result, if the belt speed is set, the cutter nozzle travel speed is also set. On the other hand, with the apparatus and method of the present disclosure, the width of the work product being cut can be variable, and also the cut speed can vary. For example, the cutter can travel very quickly across the belt, but also down the belt (in the direction of the belt movement) at the same time. The time saved by moving the nozzles quickly and downstream is captured by moving the nozzles back against the belt direction. As a consequence, unlike the one-axis cutting with one-width, one-belt speed and one cutter speed for a given arrangement of cutting nozzles, through the present system and disclosure, many combinations of cutting width, belt speed, and cutter speed may be utilized (including down-belt movement and across-belt movement of the cutter for a given manifold configuration).

While illustrative embodiments have been illustrated and described, it will be appreciated that various changes can be made therein without departing from the spirit and scope of the invention.

The embodiments of the invention in which an exclusive property or privilege is claimed are defined as follows:

1. A portioning system for cutting a generally continuous work product extending along a conveyor into end products by cutting the work product in a repeating diced pattern as the work product is being carried by a conveyor, comprising:
a first plurality of cutters, each presenting a cutting line extending in a direction transverse to the plane of the conveyor;
an actuator capable of moving the first plurality of cutters in unison, in directions parallel and transverse to the conveyor, either singularly or simultaneously and at a speed significantly faster than the travel speed of the conveyor to thereby to cause the first plurality of cutters to cut the work product into a plurality of diced end pieces; and
a control system capable of controlling the movement of the first plurality of cutters and the conveyor according to a plurality of directly controlled parameters selected from the group consisting of: cutter pattern width, belt speed, cutter movement speed, cutter direction of movement, shape of desired diced end products, weight of desired diced end products, size of desired diced end products.

2. The portioning system according to claim 1, wherein the directly controlled parameters include cutting pattern width, cutter movement speed and shape of diced end products, and the portioning system determines the belt speed based on the values of the directly controlled parameters selected.

3. The portioning system according to claim 2, wherein the portioning system permits adjustments to the area or weight of the diced end product, and the portioning system determines and sets the shape of the diced end product to achieve the selected area or weight of the diced end product.

4. The portioning system according to claim 1, wherein belt speed, cutter movement speed and diced end product shape are directly controlled parameters, and the portioning system based on the values of the directly controlled parameters selected determines the width of the cutting pattern.

5. The portioning system according to claim 4, wherein adjustments are permitted to the desired area or weight of the diced end products, and the portioning system determines and selects a new shape for the diced end products to achieve the selected area or weight.

6. The portioning system according to claim 1, further comprising a scanner for scanning the work product prior to cutting.

7. The portioning system according to claim 6, wherein the control system recommends or automatically adjusts the cutting pattern width based on the data from the scanner.

8. The portioning system according to claim 6, wherein the control system recommends or automatically adjusts the shape of the diced end products based on the desired weight of the end products and the information from the scanner.

9. The portioning system according to claim 6, wherein said control system monitors the volume and/or mass of work product being diced.

10. The portioning system according to claim 6, further comprising a slicer positioned either before or after the cutters, said control system controlling the slicer to slice the work product or diced end products to a desired thickness.

11. The portioning system according to claim 10, wherein the control system recommends or selects a desired slice thickness based on a selected, directly controlled parameter of the desired weight of the diced end products.

12. The portioning system according to claim 10, wherein the slicer is adjusted to slice the work product to a desired thickness based in part on the information from the scanner.

13. The portioning system according to claim 1, further comprising a slicer positioned either before or after the cutter along the conveyor for slicing the work product to a desired thickness, wherein said desired thickness is a directly controlled parameter.

14. The portioning system according to claim 1, wherein said cutter simultaneously cutting the work product along a plurality of cutting paths.

15. The portioning system according to claim 1, further comprising:
a second plurality of cutters, each presenting a cutting line extending in a direction transverse to the plane of the conveyors;
an actuator capable of moving the second plurality of cutters in unison, in directions parallel and transverse to the conveyor, either singularly or simultaneously, and at a speed significantly faster than the travel speed of the conveyor, thereby to cause the second plurality of cutters to cut the work product into a plurality of diced end pieces; and
said control system capable of controlling the movement of the second plurality of cutters in coordination with controlling the movement of the first plurality of cutters, and the conveyor according to a plurality of directly controlled parameters selected from the group consisting of: cutter pattern width, belt speed, cutter movement speed, cutter direction of movement, shape of desired diced end products, weight of desired diced end products, size of desired diced end products.

16. A two-axis portioning system for cutting a generally longitudinally continuous food product into a repeating diced pattern as the food product is being conveyed on a support system, comprising:
a cutter set comprising a plurality of cutters presenting cutting lines extending in a direction transverse to the plane of the conveyor;
an actuator capable of moving the cutter set parallel and transverse to the direction of movement of the conveyor, either in single direction or simultaneously in both parallel and transverse directions, and at a speed significantly faster than the travel speed of the conveyor;
a scanner for scanning the food product; and
a control system capable of controlling the movement of the cutter set and the conveyor and the operation of the scanner to cut the food product into a repeating diced pattern, said control system capable of recommending or automatically adjusting:
the cut pattern width of the cutter set based upon the scanned width data of the food product; and
the rhombus angle of the diced food products based on the desired weight of the diced food products and the information from scanning the food product.

17. The portioning system according to claim 16, wherein one or more of the parameters selected from the group consisting of: cutter pattern width, belt speed, cutter set travel speed, cutter set direction of movement, shape of diced food products, weight of diced food products, and size of diced food products may be directly selected, and the control system capable of controlling the movement of the cutter set and conveyor to achieve such one or more selected directly controlled parameters.

18. The portioning system according to claim 16, further comprising a slicer positioned either before or after the cutter set, said control system controlling the slicer to slice the food product either before or after cutting the food product with the cutter set to a desired thickness.

19. The portioning system according to claim 18, wherein the control system recommends or selects a desired slice thickness based on the desired weight of the diced food product.

20. A method for cutting a substantially continuous food product extending along a moving support surface into a repeating diced pattern as the food product is being carried by the moving support surface, comprising:
providing a first cutter set comprising a plurality of cutters presenting cutting lines extending in a direction transverse to the moving support surface; and
moving the first cutter set along and/or across the moving support surface at a speed significantly faster than the travel speed of the moving support surface in a repeating dicing pattern when dicing the food product, with the shape of the diced cut food products based on the desired physical parameters of the diced food product.

21. The method of claim 20, wherein the desired physical parameters of the diced food products include parameters selected from the group consisting of the shape of the diced food products, the weight of the diced food products, the thickness of the diced food products, and the size of the diced food products.

22. The method of claim 20, wherein the movement of the cutter set relative to the moving support surface is in accordance with one or more controlled parameters selected from the group consisting of cutter pattern width, support surface movement speed, cutter set movement speed, and cutter set movement direction.

23. The method according to claim 20, further comprising slicing the food product either before or after dicing the food product to achieve a desired thickness, weight, or shape of the diced food product.

24. The method according to claim 20, wherein the movement of the cutter set is automatically adjusted to achieve a desired shape of the diced food products based on the desired weight of the diced food products and the information from the scanner.

25. The method according to claim 20, wherein the movement of the cutter set is automatically adjusted based on the data from the scanner as well as one or more desired physical parameters of the diced food products selected from the group consisting of the desired shape of the diced food product, the desired weight of the diced food product, the desired thickness of the diced food product, and the desired size of the diced food product.

26. The method according to claim 20, further comprising scanning the food product prior to dicing the food product.

27. The method of claim 26, wherein the dicing pattern is adjusted based on data from the scanning of the food product.

28. The method of claim 26, further comprising adjusting the shape of the diced food products based on the data from scanning the food product.

29. The method of claim 20, further comprising:
providing at least one additional cutter set, each additional cutter set comprising a plurality of cutters presenting cutting lines extending in a direction transverse to the moving support surface; and
moving the at least one additional cutter set along and/or across the moving support surface at a speed significantly faster than the travel speed of the moving support surface in a repeating dicing pattern when dicing the food product, with the shape of the dice cut food products based on the desired physical parameters of the diced food products; and
coordinating the movement of the at least one additional cutter set with the movement of the first cutter set.
